(19) United States
(12) Patent Application Publication
(10) Pub. No.: US 2026/0237201 A1
(43) Pub. Date: Aug. 13, 2026

(54) METHODS, SYSTEMS, AND STORAGE MEDIUM FOR SMART CITY FIRE EMERGENCY PREVENTION BASED ON INTERNET OF THINGS LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guobin LUO, Chengdu (CN)

(73) Assignee: CHENGDU QINCHUAN IOT TECHNOLOGY CO., LTD., Chengdu (CN)

(21) Appl. No.: 19/638,087

(22) Filed: Apr. 2, 2026

(30) Foreign Application Priority Data
Feb. 25, 2026 (CN) 202610221804.7

(51) Int. Cl. G06V 20/17; B64U 80/30; B64U 101/30; B64U 101/47; G05D 1/46; G06V 20/10; G16Y 40/10

(52) U.S. Cl. CPC G06V 20/17; B64U 80/30; G05D 1/46; G06V 20/188; G16Y 40/10; B64U 2101/30; B64U 2101/47

(57) ABSTRACT

Provided are a system, method, and storage medium for smart city fire emergency prevention based on an Internet of Things large model. The method includes: determining a plurality of fire risk coefficients of a plurality of preset regions based on a temperature distribution, a crowd distribution, a region type, and historical danger data of the plurality of preset regions; determining a target region based on the plurality of fire risk coefficients and a plurality of risk thresholds; and generating a monitoring instruction including a sampling point and a sampling amount based on a fire risk coefficient of the target region, and sending the monitoring instruction to an emergency supervision object platform through an emergency supervision sensing network platform, to control an unmanned aerial vehicle (UAV) of the emergency supervision object platform to move to the sampling point and acquire monitoring data corresponding to the sampling amount at the sampling point.

### CROSS-REFERENCE TO RELATED APPLICATIONS

This application claims priority to Chinese Patent Application No. 202610221804.7, filed on Feb. 25, 2026, the entire contents of which are hereby incorporated by reference.

### TECHNICAL FIELD

The present disclosure generally relates to a field of fire prevention, and in particular, to a system, a method, and a storage medium for smart city fire emergency prevention based on an Internet of Things large model.

### BACKGROUND

With the acceleration of urbanization, the demand for fire prevention and control in suburban regions within smart city construction is becoming increasingly urgent. Suburban regions typically have high vegetation coverage, complex terrain, and limited rescue resources. Once a fire occurs, it can easily cause large-scale ecological and property losses.

Currently, emergency prevention for suburban fires is based on static monitoring networks constructed using temperature sensors, smoke detectors, and surveillance cameras at fixed locations. Such systems have coverage blind spots, difficulty in capturing dynamic fire situations (e.g., wildfire spread) in real time, and are susceptible to environmental interference (e.g., heavy fog, low nighttime illumination), leading to frequent false alarms or missed detections. Fire monitoring through manual periodic inspections and satellite thermal imaging suffers from significant response delays, making it difficult to locate early fire sources.

To address the above problems, there is an urgent need for a system, a method, and a medium for smart city fire emergency prevention based on an Internet of Things large model which can quickly evaluate fire risk coefficients of different regions, thereby determining regions requiring key monitoring, and utilizing unmanned aerial vehicles (UAVs) to timely collect relevant data within the regions, providing data reference for fire emergency response.

### SUMMARY

One or more embodiments of the present disclosure provide a system for smart city fire emergency prevention based on an Internet of Things (IoT) large model, comprising: an emergency supervision user platform, an emergency supervision service platform, an emergency supervision management platform, an emergency supervision sensing network platform, and an emergency supervision object platform, wherein the emergency supervision management platform is configured to, at each preset period: determine a plurality of fire risk coefficients of a plurality of preset regions based on a temperature distribution, a crowd distribution, a region type, and historical danger data of the plurality of preset regions; determine a target region based on the plurality of fire risk coefficients and a plurality of risk thresholds; and generate a monitoring instruction including a sampling point and a sampling amount based on a fire risk coefficient of the target region, and send the monitoring instruction to the emergency supervision object platform through the emergency supervision sensing network platform, to control an unmanned aerial vehicle (UAV) of the emergency supervision object platform to move to the sampling point and acquire monitoring data corresponding to the sampling amount at the sampling point.

One or more embodiments of the present disclosure provide a method for smart city fire emergency prevention. The method is performed by an emergency supervision management platform in a system for smart city fire emergency prevention based on an Internet of Things (IoT) large model at each preset period, and comprises: determining a plurality of fire risk coefficients of a plurality of preset regions based on a temperature distribution, a crowd distribution, a region type, and historical danger data of the plurality of preset regions; determining a target region based on the plurality of fire risk coefficients and a plurality of risk thresholds; and generating a monitoring instruction including a sampling point and a sampling amount based on a fire risk coefficient of the target region, and sending the monitoring instruction to an emergency supervision object platform through an emergency supervision sensing network platform, to control an unmanned aerial vehicle (UAV) of the emergency supervision object platform to move to the sampling point and acquire monitoring data corresponding to the sampling amount at the sampling point.

One or more embodiments of the present disclosure provide a non-transitory computer-readable storage medium, wherein the storage medium stores computer instructions, and when a computer reads the computer instructions in the storage medium, the computer executes the method for smart city fire emergency prevention.

### BRIEF DESCRIPTION OF THE DRAWINGS

The present disclosure will be further described by way of exemplary embodiments, which will be described in detail with reference to the accompanying drawings. These embodiments are not limiting, and in these embodiments, the same reference numerals denote the same structures, wherein:

FIG. 1 is a schematic diagram illustrating an exemplary structure of a system for smart city fire emergency prevention based on an Internet of Things large model according to some embodiments of the present disclosure;

FIG. 2 is a flowchart illustrating an exemplary process for smart city fire emergency prevention according to some embodiments of the present disclosure;

FIG. 3 is a schematic diagram illustrating an exemplary process for determining whether a fire exists in a target region based on an anomaly recognition model according to some embodiments of the present disclosure; and

FIG. 4 is a flowchart illustrating an exemplary process for generating a delivery instruction according to some embodiments of the present disclosure.

### DETAILED DESCRIPTION

The drawings used in the description of the embodiments are briefly introduced below. The drawings do not represent all embodiments.

The embodiments in the present disclosure are merely for illustration and description, and do not limit the scope of the present disclosure. For those skilled in the art, various modifications and changes that can be made under the guidance of the present disclosure still fall within the scope of the present disclosure. In addition, certain features, structures, or characteristics in one or more embodiments of the present disclosure may be appropriately combined. As indicated in the present disclosure and in the claims, the singular forms “a,” “an,” and “the” may be intended to include the plural forms as well, unless the context clearly indicates otherwise.

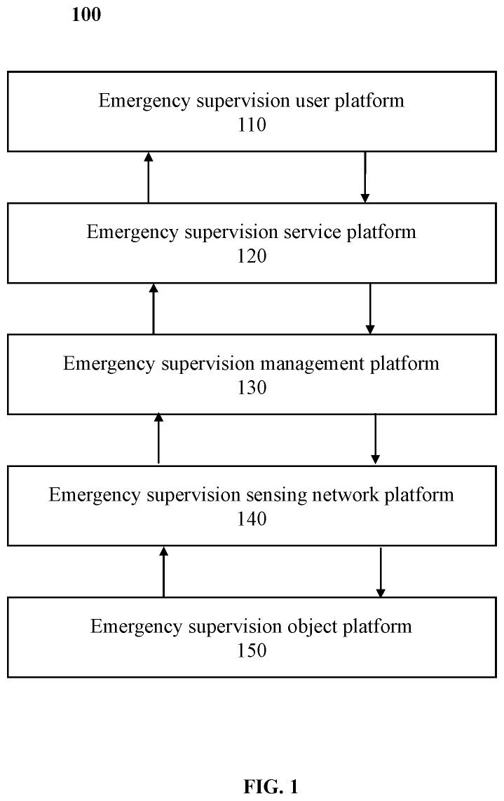

FIG. 1 is a schematic diagram illustrating an exemplary structure of a system for smart city fire emergency prevention based on an Internet of Things large model according to some embodiments of the present disclosure.

In some embodiments, as shown in FIG. 1, a system 100 for smart city fire emergency prevention based on an Internet of Things large model may include an emergency supervision user platform 110, an emergency supervision service platform 120, an emergency supervision management platform 130, an emergency supervision sensing network platform 140, and an emergency supervision object platform 150.

The emergency supervision user platform 110 refers to a platform for interacting with a user (e.g., a supervisor). In some embodiments, the emergency supervision user platform 110 includes a terminal device. Merely by way of example, the terminal device may include a mobile device, a tablet computer, a console, or the like.

The emergency supervision service platform 120 refers to a platform for receiving and transmitting data and/or information. In some embodiments, the emergency supervision service platform 120 is configured as a server, a processor, or the like. The emergency supervision service platform 120 may interact bidirectionally with the emergency supervision user platform 110 and the emergency supervision management platform 130.

The emergency supervision management platform 130 refers to a comprehensive management platform for managing, coordinating, and coordinating connections and collaborations among a plurality of platforms. In some embodiments, the emergency supervision management platform 130 is configured as a server, a processor, or the like. The emergency supervision management platform 130 may interact bidirectionally with the emergency supervision service platform 120 and the emergency supervision sensing network platform 140. For example, the emergency supervision management platform 130 may obtain monitoring data from the emergency supervision object platform 150 through the emergency supervision sensing network platform 140. As another example, the emergency supervision management platform 130 may issue a control instruction (e.g., a monitoring instruction) to the emergency supervision object platform 150 through the emergency supervision sensing network platform 140 to control an unmanned aerial vehicle (UAV) of the emergency supervision object platform 150 to move to a sampling point and acquire the monitoring data corresponding to a sampling amount at the sampling point.

The emergency supervision sensing network platform 140 refers to a platform for comprehensively managing sensing information. In some embodiments, the emergency supervision sensing network platform 140 is configured as a communication network, a gateway, or the like.

The emergency supervision object platform 150 refers to a platform for generating the sensing information and executing control instructions. In some embodiments, the emergency supervision object platform 150 includes the UAV, an image acquisition device, a temperature sensor, a fire alarm, or the like. The emergency supervision object platform 150 may interact bidirectionally with the emergency supervision sensing network platform 140.

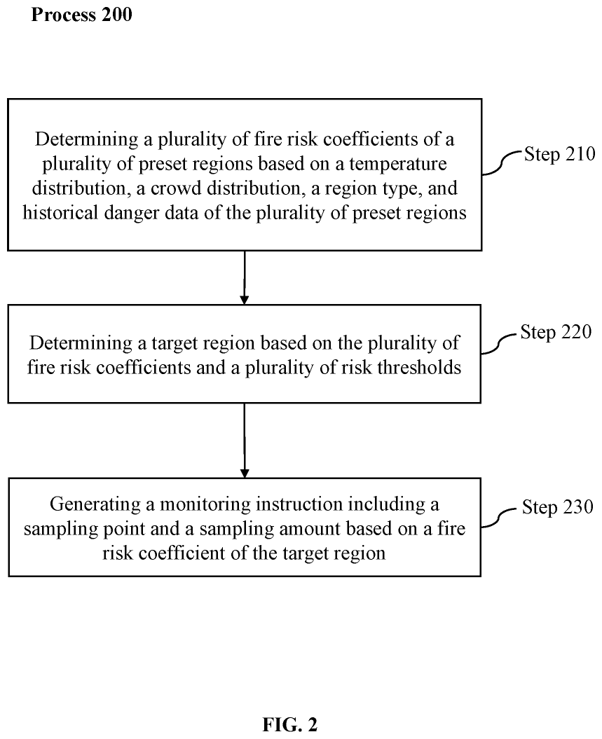

The UAV may be used to sample a target region to obtain the monitoring data. In some embodiments, a camera and a gas sensor are arranged on the UAV. More descriptions regarding the target region and the monitoring data may be found in FIG. 2 and related description thereof.

The image acquisition device may be a device for acquiring images in a specific region, for example, the image acquisition device may be a camera or an industrial camera.

The temperature sensor may be used to acquire a temperature in the specific region.

In some embodiments, the image acquisition device and the temperature sensor may be deployed at one or more preset points in a preset region.

More descriptions regarding the UAV, the image acquisition device, and the temperature sensor may be found in FIG. 2 and related description thereof.

In some embodiments of the present disclosure, through the system 100 for smart city fire emergency prevention based on an Internet of Things large model, an information operation closed loop may be formed among various functional platforms, and coordinated and regular operation may be achieved under the unified management of the emergency supervision management platform 130, thereby realizing informatization and intelligence of city fire emergency prevention.

FIG. 2 is a flowchart illustrating an exemplary process for smart city fire emergency prevention according to some embodiments of the present disclosure. As shown in FIG. 2, a process 200 includes the following steps. In some embodiments, the process 200 may be executed by the emergency supervision management platform at each preset period. The preset period may be preset based on historical experience.

Step 210, determining a plurality of fire risk coefficients of a plurality of preset regions based on a temperature distribution, a crowd distribution, a region type, and historical danger data of the plurality of preset regions.

The preset region refers to a region where a fire may occur. Merely by way of example, the plurality of preset regions include a warehouse, a park, or a grassland. In some embodiments, the plurality of preset regions may be preset based on historical experience. One preset region corresponds to a set of temperature distribution, crowd distribution, region type, and historical danger data. One preset region corresponds to one fire risk coefficient.

The temperature distribution refers to a parameter for describing temperature conditions at different locations in the preset region. In some embodiments, the temperature distribution includes temperatures of a plurality of preset points in the preset region. The preset point may be preset based on experience.

In some embodiments, for a single preset region, the emergency supervision management platform may obtain temperatures of the plurality of preset points in the preset region from the emergency supervision object platform through the emergency supervision sensing network platform, to obtain the temperature distribution. The emergency supervision object platform may obtain the temperatures of the plurality of preset points through a plurality of temperature sensors deployed at the plurality of preset points in the preset region.

The crowd distribution refers to a parameter for describing crowd conditions at different locations in the preset region. In some embodiments, the crowd distribution includes crowd densities of a plurality of sub-regions in the preset region. The sub-region may be predetermined based on experience.

In some embodiments, for a single preset region, the emergency supervision management platform may obtain images acquired by the image acquisition device from the emergency supervision object platform through the emergency supervision sensing network platform. The emergency supervision management platform may identify crowd densities of the plurality of sub-regions in the images through an image recognition algorithm (e.g., a support vector machine algorithm, a convolutional neural network (CNN) model, or the like) to obtain the crowd distribution.

In some embodiments, the emergency supervision management platform may determine a monitoring time period of the image acquisition device based on a visibility distribution of the plurality of preset regions.

The visibility distribution may reflect a distribution of visibilities of a preset region in a plurality of preset monitoring time periods. In some embodiments, the plurality of preset monitoring time periods may include a plurality of time periods of a day in historical time. The plurality of preset monitoring time periods may be preset based on historical experience. Merely by way of example, the plurality of preset monitoring time periods may be 0-8 o'clock, 8 -18 o'clock, and 18-24 o'clock of a day in historical time.

In some embodiments, for a single preset region, the emergency supervision management platform may count visibilities of the preset region in a plurality of the same preset monitoring time periods in historical data, and use an average value of the visibilities as the visibility in the preset monitoring time period to obtain the visibility distribution. The emergency supervision management platform determines the visibilities of a single preset region in the plurality of preset monitoring time periods through the above manner.

In some embodiments, the emergency supervision management platform may identify edge sharpness of images acquired by the image acquisition device in the preset monitoring time period through an edge detection algorithm or the like, and determine the visibility of the preset region in the preset monitoring time period based on the edge sharpness. A higher edge sharpness indicates a higher visibility. The edge detection algorithm may include a Canny edge detection algorithm or the like.

The monitoring time period refers to a time period during which the image acquisition device acquires monitoring data. In some embodiments, for a single preset region, the emergency supervision management platform may use a preset monitoring time period with a visibility greater than a visibility threshold as a monitoring time period of the image acquisition device in the preset region based on the visibility distribution of the preset region. The visibility threshold may be preset based on historical experience.

In some embodiments of the present disclosure, since image accuracy of images acquired by the image acquisition device varies under different visibility conditions, setting a time period with a higher visibility as the monitoring time period can ensure the image accuracy of images acquired by the image acquisition device, which is beneficial for improving accuracy of the subsequently determined fire risk coefficient.

In some embodiments, when determining the plurality of fire risk coefficients of the plurality of preset regions, the emergency supervision management platform may further replace the temperature distribution and the crowd distribution of the plurality of preset regions with a future temperature distribution and a future crowd distribution.

In some embodiments, the emergency supervision management platform may determine the future temperature distribution and the future crowd distribution of the plurality of preset regions based on the temperature distribution and the crowd distribution of the plurality of preset regions. One preset region corresponds to a set of the future temperature distribution and the future crowd distribution.

The future temperature distribution refers to a temperature distribution in a preset future time period. The preset future time period may be preset based on historical experience.

The future crowd distribution refers to a crowd distribution in the preset future time period.

In some embodiments, the emergency supervision management platform may determine the future temperature distribution and the future crowd distribution of the plurality of preset regions through a distribution prediction model based on the temperature distribution and the crowd distribution of the plurality of preset regions.

In some embodiments, the distribution prediction model is a machine learning model. Merely by way of example, the distribution prediction model includes a neural network (NN) model, a convolutional neural network (CNN) model, other custom model structures, or any combination thereof.

In some embodiments, an input of the distribution prediction model includes a temperature distribution and a crowd distribution of a single preset region. An output of the distribution prediction model includes a future temperature distribution and a future crowd distribution of the single preset region.

In some embodiments, the emergency supervision management platform may obtain the distribution prediction model by training using a plurality of first training samples with first labels through a gradient descent manner or the like. The first training sample includes a sample temperature distribution and a sample crowd distribution of a sample preset region in a first historical time period. The first label includes a temperature distribution and a crowd distribution of the sample preset region in a second historical time period. The first historical time period is earlier than the second historical time period.

In some embodiments, the first training samples and the first labels may be obtained from historical data.

In some embodiments, a training process of the distribution prediction model includes: the emergency supervision management platform inputting the plurality of first training samples into an initial distribution prediction model, constructing a loss function based on the first label and an output result of the initial distribution prediction model, and then iteratively updating parameters of the initial distribution prediction model based on the loss function. When a training condition is satisfied, model training is completed, and a trained distribution prediction model is obtained. The training condition may be convergence of the loss function, a count of iterations reaching a number threshold, or the like.

In some embodiments of the present disclosure, by considering the future temperature distribution and the future crowd distribution when determining the fire risk coefficient, the determined fire risk coefficient may be more accurate. By using the distribution prediction model, a more accurate future temperature distribution and future crowd distribution can be determined.

The region type is configured to describe a type of the preset region. In some embodiments, the region type may include an urban region or a suburban region. The region type may be obtained through a user input.

The historical danger data refers to data related to the fire that occurred in the preset region in historical data. In some embodiments, the historical danger data includes a historical temperature distribution, a historical crowd distribution, and an actual loss each time a fire occurred in the preset region at the historical time. The actual loss may be an economic loss caused by the fire, or the like. The actual loss may be confirmed and labeled by technical personnel and then uploaded to the emergency supervision management platform.

The fire risk coefficient refers to an indicator used to comprehensively evaluate a probability of a fire occurring in the preset region and a possible loss caused by the fire. In some embodiments, a higher fire risk coefficient indicates a higher probability of the fire occurring and a greater possible loss.

In some embodiments, for a single preset region, the emergency supervision management platform may construct feature vectors based on the temperature distribution, the crowd distribution, and the region type of the preset region at a plurality of historical time points in the historical data to obtain a plurality of first-type vectors. The emergency supervision management platform may construct feature vectors based on the historical temperature distribution, the historical crowd distribution, and the region type each time the fire occurred in historical danger data of the preset region, to obtain a plurality of second-type vectors. The emergency supervision management platform may construct feature vectors based on a current temperature distribution, a current crowd distribution, and a current region type, to obtain a third-type vector. The plurality of historical time points may be preset based on historical experience. The first-type vectors and the third-type vector carry no labels, and labels of the second-type vectors are the actual loss in the historical danger data.

In some embodiments, the emergency supervision management platform performs clustering processing on the first-type vectors, the second-type vectors, and the third-type vector through a clustering algorithm to determine at least one cluster center. For a cluster center that includes the third-type vector, the emergency supervision management platform determines a count of second-type vectors included in the cluster center and a total count of feature vectors, uses a ratio of the count of the second-type vectors to the total count of the feature vectors as a probability of a fire occurring, and uses a mean value of actual losses in labels of all the second-type vectors as the possible loss. The clustering algorithm may include a K-Means clustering algorithm, or the like.

In some embodiments, the emergency supervision management platform may determine the fire risk coefficient based on the probability of the fire occurring and the possible loss. Merely by way of example, the emergency supervision management platform may perform normalization processing on the probability of the fire occurring and the possible loss and then perform weighted summation to obtain the fire risk coefficient. A weight of the probability of the fire occurring and a weight of the possible loss may be preset.

Step 220, determining a target region based on the plurality of fire risk coefficients and a plurality of risk thresholds.

The risk threshold may be a maximum value of an acceptable fire risk coefficient. In some embodiments, one preset region corresponds to one risk threshold. Risk thresholds corresponding to different preset regions may be the same or different. The risk threshold may be preset based on experience.

In some embodiments, the risk threshold may be negatively correlated with a vegetation quantity in the preset region, i.e., a larger vegetation quantity corresponds to a lower risk threshold. The vegetation quantity in the region may be determined by the user input, and the emergency supervision management platform may also obtain the vegetation quantity in the preset region by identifying images acquired by the image acquisition device through the image recognition algorithm.

It can be understood that a larger vegetation quantity in the region leads to a faster fire spread speed. In this case, the risk threshold needs to be lowered to respond to a fire situation in a timely manner and reduce a loss.

The target region refers to a preset region among a plurality of preset regions that requires key monitoring.

In some embodiments, the emergency supervision management platform may determine the target region based on the plurality of fire risk coefficients and the plurality of risk thresholds. Merely by way of example, the emergency supervision management platform may designate a preset region among the plurality of preset regions where the fire risk coefficient is greater than the corresponding risk threshold as the target region.

Step 230, generating a monitoring instruction including a sampling point and a sampling amount based on a fire risk coefficient of the target region.

The monitoring instruction is an instruction configured to guide an UAV to acquire the monitoring data. In some embodiments, the monitoring instruction includes the sampling point and the sampling amount. The sampling point refers to a location for acquiring the monitoring data. The sampling amount refers to a data amount of acquired the monitoring data.

The monitoring data may be data obtained after monitoring the target region. In some embodiments, the monitoring data may include at least one of image data (e.g., plant images) captured by a camera of the UAV, gas-related data (e.g., a smoke concentration and concentrations of a plurality of substances in air) obtained by a gas sensor of the UAV, or the like.

In some embodiments, the emergency supervision management platform may query a first preset table for a sampling point quantity and a sampling amount corresponding to the fire risk coefficient of the target region, determine locations of a plurality of sampling points according to the sampling point quantity, and generate the monitoring instruction based on the plurality of sampling points and the sampling amount. The emergency supervision management platform may set locations of a plurality of sampling points in the target region in a plurality of manners based on the sampling point quantity. The plurality of manners includes equal-spacing setting, or the like.

In some embodiments, the first preset table may be preset based on historical experience. The first preset table includes a correspondence among a plurality of fire risk coefficients, sampling point quantities, and sampling amounts.

In some embodiments, the emergency supervision management platform sends the monitoring instruction to the emergency supervision object platform through the emergency supervision sensing network platform to control the UAV of the emergency supervision object platform to move to the sampling point and obtain the monitoring data corresponding to the sampling amount at the sampling point.

In some embodiments of the present disclosure, the fire risk coefficient of the preset region may be quickly evaluated based on the temperature distribution, the crowd distribution, the region type, and the historical danger data. Therefore, the target region that needs further screening by the UAV for key monitoring may be screened from the plurality of preset regions. At the same time, a more appropriate monitoring instruction may be determined based on the fire risk coefficient, so that the UAV can collect a sufficient amount of data of the target region, which avoids insufficient data volume and is beneficial for subsequently taking corresponding measures for the fire in the target region in a timely manner.

In some embodiments, the emergency supervision management platform may determine air-related data and vegetation-related data of the target region based on monitoring data, and determine whether a fire exists in the target region based on the air-related data and the vegetation-related data.

The air-related data refers to data related to air quality. In some embodiments, the air-related data may include the smoke concentration and a target substance concentration.

The smoke concentration refers to a concentration of smoke in the target region.

The target substance concentration refers to a concentration of a target substance in air in the target region. The target substance may be a substance that reflects a possibility of a fire occurring. In some embodiments, the target substance may include a volatile organic compound released by an oily plant, or the like. In some embodiments, the oily plant may include a eucalyptus tree, a pine tree, or the like. The volatile organic compound may include isoprene, monoterpene, or the like.

In some embodiments, the emergency supervision management platform may determine the smoke concentration and the target substance concentration of the target region based on the smoke concentration and concentrations of the plurality of substances in air collected by the gas sensor on the UAV.

The vegetation-related data refers to data related to plants. In some embodiments, the vegetation-related data may include a leaf curling degree of a plant in the target region, a dead leaf distribution, or the like. The leaf curling degree of the plant may include a direction and a degree of leaf curling of the plant, or the like.

The dead leaf distribution is used to characterize a distribution of dead leaves in the target region. In some embodiments, the dead leaf distribution may be represented by dead leaf amounts of a plurality of sub-regions in the target region. The dead leaf may be a leaf of a dark color (e.g., dark brown, or the like).

In some embodiments, the emergency supervision management platform may analyze plant images collected by the UAV to obtain the vegetation-related data. For example, the emergency supervision management platform identifies dead leaf amounts of a plurality of sub-regions in the plant image through the image recognition algorithm, based on the plant image collected by the UAV to obtain the dead leaf distribution. As another example, the emergency supervision management platform identifies the direction and the leaf curling degree of the plant in the plant image through the image recognition algorithm based on the plant image collected by the UAV to obtain the leaf curling degree. The plant image may be an image with plants as a shooting object.

In some embodiments, the emergency supervision management platform may determine whether a fire exists in the target region based on the air-related data and the vegetation-related data. Merely by way of example, the emergency supervision management platform may construct a target feature vector based on the air-related data and the vegetation-related data, query a first feature vector that satisfies a matching condition in a first vector library, and determine whether a fire exists in the target region based on a label corresponding to the first feature vector. The matching condition includes having a highest vector similarity between vectors. The vector similarity is negatively correlated with a vector distance. The vector distance includes a Euclidean distance, or the like.

In some embodiments, the first vector library may be preset based on historical data. The first vector library includes a plurality of first feature vectors and a label corresponding to each first feature vector. The first feature vector refers to a feature vector constructed based on historical air-related data and historical vegetation-related data. The label may be whether a fire existed in a historical target region corresponding to the first feature vector.

In some embodiments, the emergency supervision management platform may calculate a probability of a fire occurring in the historical target region corresponding to the first feature vector in a third historical time period. In response to a determination that the probability of the fire occurring is greater than a fire threshold, the emergency supervision management platform determines that the label corresponding to the first feature vector indicates that a fire exists. In response to a determination that the probability of the fire occurring is not greater than the fire threshold, the emergency supervision management platform determines that the label corresponding to the first feature vector indicates that a fire does not exist. The third historical time period may be a time period after the historical air-related data and the historical vegetation-related data of the historical target region are obtained. The third historical time period is preset based on historical experience. The third historical time period includes a plurality of historical moments.

In some embodiments, the emergency supervision management platform may obtain a quantity of fire alarms triggered by fire alarms at the plurality of historical moments within the third historical time period. The emergency supervision management platform determines a ratio of the quantity of triggered alarms to a total quantity of historical moments as the probability of the fire occurring. The fire alarms may be deployed at the plurality of preset points in the preset region and the target region.

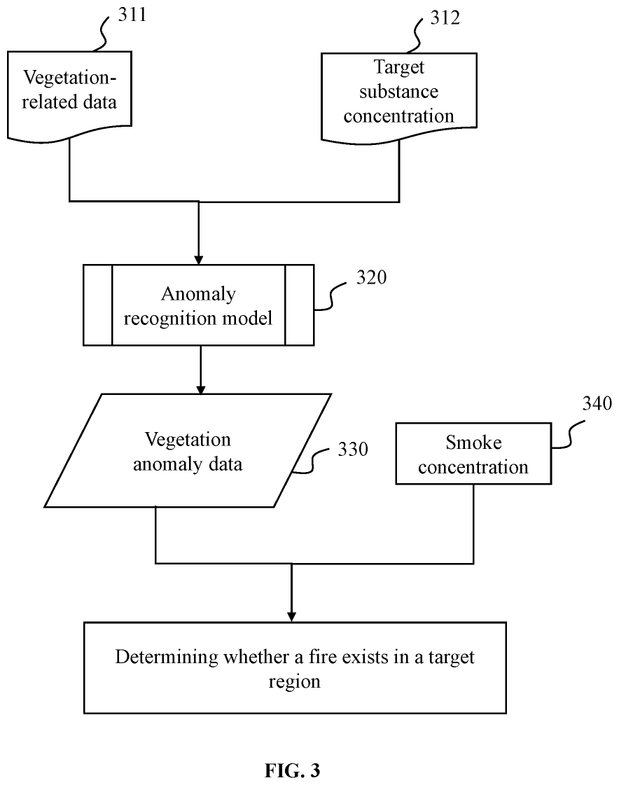

In some embodiments, the emergency supervision management platform may also determine whether a fire exists in the target region through an anomaly recognition model. More descriptions regarding the anomaly recognition model may be found in FIG. 3 and related description thereof.

In some embodiments of the present disclosure, whether a fire occurs in the target region can be comprehensively and accurately determined based on the air quality of the target region and a possible withering situation of vegetation.

FIG. 3 is an exemplary schematic diagram illustrating determine whether a fire exists in a target region based on an anomaly recognition model according to some embodiments of the present disclosure.

In some embodiments, the emergency supervision management platform may also determine vegetation anomaly data 330 of a target region through an anomaly recognition model 320 based on vegetation-related data 311 and a target substance concentration 312. The emergency supervision management platform determines whether a fire exists in the target region based on the vegetation anomaly data 330 and a smoke concentration 340. More descriptions regarding the vegetation-related data, the target substance concentration, and the smoke concentration may be found in FIG. 2 and related description thereof.

The vegetation anomaly data may reflect an anomaly of vegetation in the target region in a preset future period. In some embodiments, the vegetation anomaly data may include a location and an anomaly degree of abnormal vegetation in the target region. More descriptions regarding the preset future period may be found in FIG. 2 and related description thereof. The abnormal vegetation may be a plant with leaf curling, withering, or the like, due to high temperature.

In some embodiments, the anomaly recognition model is a machine learning model. Merely by way of example, the anomaly recognition model is any one or a combination of a deep neural network (DNN) model, a recurrent neural network (RNN) model, other custom model structures, or any combination thereof.

In some embodiments, the emergency supervision management platform may obtain the anomaly recognition model through training using a plurality of second training samples with second labels through a gradient descent manner or the like.

In some embodiments, the second training sample includes sample vegetation-related data and a sample target substance concentration. The second label includes actual vegetation anomaly data corresponding to the second training sample.

In some embodiments, the second training sample and the second label may be determined based on historical data. For example, the emergency supervision management platform may obtain historical vegetation-related data and a historical target substance concentration in historical data as the second training sample, and obtain vegetation anomaly data within a fourth historical time period corresponding to the second training sample as the second label. The fourth historical time period may be a time period after the historical vegetation-related data in the second training sample is obtained. The fourth historical time period has a same duration as the preset future time period.

In some embodiments, for a plurality of sub-regions of a historical target region corresponding to the second training sample, the emergency supervision management platform may perform a weighted summation on a historical dead leaf amount, a historical leaf curling degree, and a historical target substance concentration of each sub-region based on the historical vegetation-related data and the historical target substance concentration within a second historical time period, determine a sub-region with a weighted summation value greater than an anomaly threshold as a location of abnormal vegetation in the second label, and use the weighted summation value as an anomaly degree in the second label. Respective weights of the historical dead leaf amount, the historical leaf curling degree, and the historical target substance concentration may be determined based on empirical preset. The anomaly threshold may be preset based on experience.

In some embodiments, the emergency supervision management platform may perform normalization processing on the historical dead leaf amount, the historical leaf curling degree, and the historical target substance concentration before the weighted summation.

In some embodiments, the training manner of the anomaly recognition model is similar to the training manner of the distribution prediction model, and details are not repeated herein.

In some embodiments, the emergency supervision management platform may determine whether a fire exists in the target region based on the vegetation anomaly data and the smoke concentration. For example, the emergency supervision management platform may calculate an abnormal vegetation density and an average anomaly degree in the vegetation anomaly data, query a label corresponding to the abnormal vegetation density, the average anomaly degree, and the smoke concentration in a second preset table, and determine whether a fire exists in the target region based on the label. The abnormal vegetation density may be a ratio of a quantity of abnormal vegetation to an area of the target region.

In some embodiments, the second preset table may be preset based on historical data. The second preset table includes a plurality of groups of abnormal location density, average anomaly degree, and smoke concentration, and includes labels corresponding to the plurality of groups of data. The label may indicate whether a fire exists in the target region. The second preset table may be preset based on experience. More descriptions regarding the smoke concentration may be found in FIG. 2 and related description thereof.

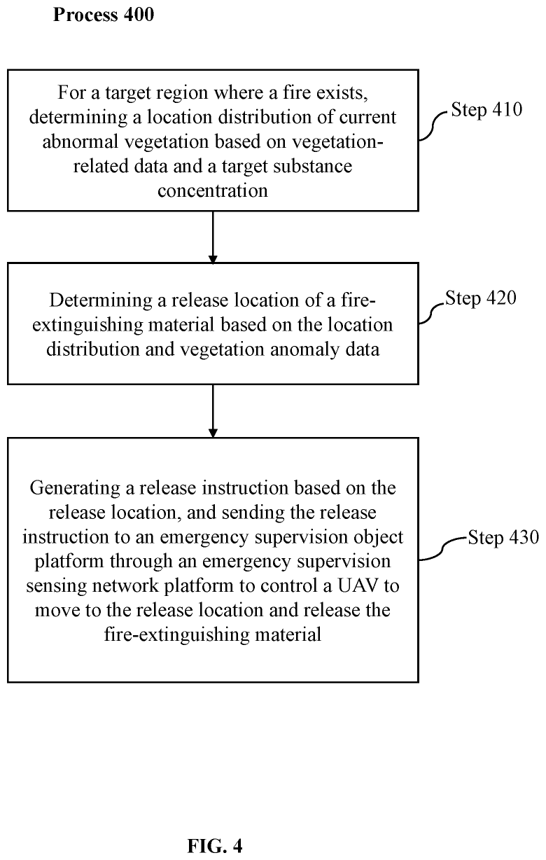

In some embodiments, for a region where a fire exists, the emergency supervision management platform may determine a release location of a fire-extinguishing material and generate a release instruction based on the vegetation-related data and the target substance concentration, send the release instruction to the emergency supervision object platform through the emergency supervision sensing network platform, to control an UAV to move to the release location and release the fire-extinguishing material for fire extinguishing. More descriptions may be found in FIG. 4 and related description thereof.

In some embodiments of the present disclosure, by using the anomaly recognition model to estimate the vegetation anomaly data within the preset future time period, whether a fire currently exists in the target region can be determined by predicting abnormal conditions of vegetation in a future time, which reduces errors of subjective judgment and improves efficiency and reliability of fire determination.

FIG. 4 is an exemplary flowchart illustrating the generation of a delivery instruction according to some embodiments of the present disclosure. As shown in FIG. 4, a process 400 includes the following steps. In some embodiments, the process 400 may be performed by the emergency supervision management platform.

Step 410, for a target region where a fire exists, determining a location distribution of current abnormal vegetation based on vegetation-related data and a target substance concentration. More descriptions regarding the vegetation-related data and the target substance concentration may be found in FIG. 3 and related description thereof.

The location distribution of the current abnormal vegetation may reflect a distribution of abnormal vegetation at a current moment. More descriptions regarding the abnormal vegetation may be found in FIG. 3 and related description thereof.

In some embodiments, the emergency supervision management platform may perform a weighted summation on current vegetation-related data and the target substance concentration in the target region, determine a plurality of locations with weighted summation values greater than an anomaly threshold as locations of current abnormal vegetation, and obtain the location distribution of the current abnormal vegetation based on the locations of the current abnormal vegetation. More descriptions regarding the weighted summation and the anomaly threshold may be found in FIG. 3 and related description thereof.

Step 420, determining a release location of a fire-extinguishing material based on the location distribution and vegetation anomaly data.

The fire-extinguishing material refers to a material used for fire extinguishing, e.g., fire extinguishing agents, or the like.

The release location refers to a location where an UAV releases the fire-extinguishing material.

In some embodiments, the emergency supervision management platform may determine the release location of the fire-extinguishing material based on the location distribution and the vegetation anomaly data. For example, the emergency supervision management platform may record locations of the current abnormal vegetation in the location distribution and locations of the abnormal vegetation in the vegetation anomaly data as release locations.

In some embodiments, the emergency supervision management platform may send the release location to the UAV, and the UAV releases the fire-extinguishing material to the release location. There may be a plurality of release locations.

Step 430, generating a release instruction based on the release location, and sending the release instruction to an emergency supervision object platform through an emergency supervision sensing network platform, to control the UAV to move to the release location and release the fire-extinguishing material.

The release instruction refers to an instruction that guides release of the fire-extinguishing material. In some embodiments, the release instruction may include the release location for releasing the fire-extinguishing material, etc. The emergency supervision management platform may generate the release instruction based on the release location, and send the release instruction to the emergency supervision object platform through the emergency supervision sensing network platform, to control the UAV to move to the release location and release the fire-extinguishing material.

In some embodiments of the present disclosure, by using locations of the abnormal vegetation at a current moment and locations of predicted abnormal vegetation as release locations for releasing the fire-extinguishing material, more comprehensive release locations can be determined, the fire can be eliminated in a timely manner, and omission of some regions can be avoided.

In some embodiments, the release instruction may further include a release dosage of the fire-extinguishing material and a hovering height of the UAV.

In some embodiments, the emergency supervision management platform may determine a fire severity of the target region based on the vegetation anomaly data, and determine the release dosage and the hovering height based on the fire severity. The emergency supervision management platform generates the release instruction based on the release dosage and the hovering height, and sends the release instruction to the emergency supervision object platform through the emergency supervision sensing network platform, to control the UAV to hover at the release location at the hovering height and release the fire-extinguishing material at the release dosage.

The fire severity may reflect a severity of a fire occurring in the target region during the preset future time period. In some embodiments, the fire severity may include fire severities of a plurality of sub-regions within the target region, etc. More descriptions regarding the preset future time period may be found in FIG. 2 and related description thereof.

In some embodiments, the emergency supervision management platform may determine a fire severity of each sub-region within the target region based on the vegetation anomaly data. For example, for a single sub-region, the emergency supervision management platform calculates an average of anomaly degrees corresponding to locations of abnormal vegetation within the sub-region, and uses the average of the anomaly degrees as the fire severity of the sub-region.

The release dosage refers to an amount of the fire-extinguishing material to be released.

The hovering height refers to a hovering height of the UAV relative to ground of the target region. In some embodiments, a sub-region corresponds to a set of a release dosage and a hovering height.

In some embodiments, the emergency supervision management platform may determine the release dosage and the hovering height based on the fire severity. Merely by way of example, for each sub-region, the emergency supervision management platform may construct a vector to be matched based on the fire severity of the sub-region, query a second reference vector in a second vector library that satisfies a matching condition with the vector to be matched, and determine a label of the second reference vector as the release dosage and the hovering height.

In some embodiments, the second vector library may be preset based on historical data and includes a plurality of second reference vectors and labels corresponding to the plurality of second reference vectors. Merely by way of example, for each sub-region, the emergency supervision management platform may construct the plurality of second reference vectors based on a plurality of historical fire severities of the sub-region in historical data, and use a historical release dosage and a historical hovering height corresponding to each historical fire severity of the plurality of historical fire severities as a label of a corresponding second reference vector of the plurality of second reference vectors.

In some embodiments, the emergency supervision management platform may screen the second reference vectors. The screening process includes: obtaining a fire extinguishing time and a loss degree suffered by the UAV when releasing the fire-extinguishing material corresponding to the second reference vector; performing normalization processing on the fire extinguishing time and the loss degree and performing a weighted summation; retaining a second reference vector with a weighted summation value greater than a preset effect threshold; and removing a second reference vector with a weighted summation value not greater than the preset effect threshold. The fire extinguishing time may be a duration spent for a fire to disappear and is determined based on historical data. The loss may be represented by an area of the UAV scorched by fire and is determined based on historical data. A weight of the fire extinguishing time and a weight of the loss degree may be preset based on experience.

In some embodiments, the emergency supervision management platform may send the release instruction to the emergency supervision object platform through the emergency supervision sensing network platform to control the UAV to hover at the release location at the hovering height and release the fire-extinguishing material at the release dosage.

In some embodiments of the present disclosure, estimating the fire severity of the target region based on the vegetation anomaly data and determining the release dosage and the hovering height can determine the release dosage and the hovering height that are more effective for fire extinguishing in view of possible development of the fire, ensure a fire extinguishing effect, and reduce a service life loss of the UAV.

The present disclosure further provides a non-transitory computer-readable storage medium, wherein the storage medium stores computer instructions, and when a computer reads the computer instructions in the storage medium, the computer executes the method for smart city fire emergency prevention described in the foregoing embodiments.

The foregoing descriptions of the basic concepts are illustrative. Obviously, for a person skilled in the art, the foregoing detailed disclosure is merely an example and does not constitute a limitation to the present disclosure. Although not explicitly stated herein, a person skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

It should be understood that the embodiments described in the present disclosure are only used to illustrate principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly described and introduced in the present disclosure.

What is claimed is:

1. A system for smart city fire emergency prevention based on an Internet of Things (IoT) large model, comprising: an emergency supervision user platform, an emergency supervision service platform, an emergency supervision management platform, an emergency supervision sensing network platform, and an emergency supervision object platform, wherein the emergency supervision management platform is configured to, at each preset period:
determine a plurality of fire risk coefficients of a plurality of preset regions based on a temperature distribution, a crowd distribution, a region type, and historical danger data of the plurality of preset regions;
determine a target region based on the plurality of fire risk coefficients and a plurality of risk thresholds; and
generate a monitoring instruction including a sampling point and a sampling amount based on a fire risk coefficient of the target region, and send the monitoring instruction to the emergency supervision object platform through the emergency supervision sensing network platform, to control an unmanned aerial vehicle (UAV) of the emergency supervision object platform to move to the sampling point and acquire monitoring data corresponding to the sampling amount at the sampling point.

2. The system according to claim 1, wherein the emergency supervision management platform is further configured to:
determine a future temperature distribution and a future crowd distribution of the plurality of preset regions based on the temperature distribution and the crowd distribution of the plurality of preset regions.

3. The system according to claim 1, wherein the emergency supervision management platform is further configured to:
determine a monitoring time period of an image acquisition device based on a visibility distribution of the plurality of preset regions.

4. The system according to claim 1, wherein the emergency supervision management platform is further configured to:
determine air-related data and vegetation-related data of the target region based on the monitoring data, wherein the air-related data includes a smoke concentration and a target substance concentration; and
determine whether a fire exists in the target region based on the air-related data and the vegetation-related data.

5. The system according to claim 4, wherein the emergency supervision management platform is further configured to:
determine vegetation anomaly data of the target region through an anomaly recognition model based on the vegetation-related data and the target substance concentration, wherein the anomaly recognition model is a machine learning model; and
determine whether the fire exists in the target region based on the vegetation anomaly data and the smoke concentration.

6. The system according to claim 4, wherein the emergency supervision management platform is further configured to:
for the target region where the fire exists, determine a location distribution of current abnormal vegetation based on the vegetation-related data and the target substance concentration;
determine a release location of a fire-extinguishing material based on the location distribution and vegetation anomaly data; and
generate a release instruction based on the release location, and send the release instruction to the emergency supervision object platform through the emergency supervision sensing network platform, to control the UAV to move to the release location and release the fire-extinguishing material.

7. The system according to claim 6, wherein the release instruction includes a release dosage of the fire-extinguishing material and a hovering height of the UAV, and the emergency supervision management platform is further configured to:
determine a fire severity of the target region based on the vegetation anomaly data;
determine the release dosage and the hovering height based on the fire severity; and
generate the release instruction based on the release dosage and the hovering height, and send the release instruction to the emergency supervision object platform through the emergency supervision sensing network platform, to control the UAV to hover at the hovering height at the release location and release the fire-extinguishing material at the release dosage.

8. A method for smart city fire emergency prevention, wherein the method is performed by an emergency supervision management platform in a system for smart city fire emergency prevention based on an Internet of Things (IoT) large model at each preset period, and comprises:
determining a plurality of fire risk coefficients of a plurality of preset regions based on a temperature distribution, a crowd distribution, a region type, and historical danger data of the plurality of preset regions;
determining a target region based on the plurality of fire risk coefficients and a plurality of risk thresholds; and
generating a monitoring instruction including a sampling point and a sampling amount based on a fire risk coefficient of the target region, and sending the monitoring instruction to an emergency supervision object platform through an emergency supervision sensing network platform, to control an unmanned aerial vehicle (UAV) of the emergency supervision object platform to move to the sampling point and acquire monitoring data corresponding to the sampling amount at the sampling point.

9. The method according to claim 8, wherein the method further comprises:
determining a future temperature distribution and a future crowd distribution of the plurality of preset regions based on the temperature distribution and the crowd distribution of the plurality of preset regions.

10. The method according to claim 8, wherein the method further comprises:
acquiring the crowd distribution through an image acquisition device of the emergency supervision object platform; and
determining a monitoring time period of the image acquisition device based on a visibility distribution of the plurality of preset regions.

11. The method according to claim 8, wherein the method further comprises:
determining air-related data and vegetation-related data of the target region based on the monitoring data, wherein the air-related data includes a smoke concentration and a target substance concentration; and
determining whether a fire exists in the target region based on the air-related data and the vegetation-related data.

12. The method according to claim 11, wherein the determining whether a fire exists in the target region based on the air-related data and the vegetation-related data includes:
determining vegetation anomaly data of the target region through an anomaly recognition model based on the vegetation-related data and the target substance concentration, wherein the anomaly recognition model is a machine learning model; and
determining whether the fire exists in the target region based on the vegetation anomaly data and the smoke concentration.

13. The method according to claim 11, wherein the method further comprises:
for the target region where the fire exists, determining a location distribution of current abnormal vegetation based on the vegetation-related data and the target substance concentration;
determining a release location of a fire-extinguishing material based on the location distribution and vegetation anomaly data; and
generating a first release instruction based on the release location, and sending the first release instruction to the emergency supervision object platform through the emergency supervision sensing network platform, to control the UAV to move to the release location and release the fire-extinguishing material.

14. The method according to claim 13, wherein the release instruction includes a release dosage of the fire-extinguishing material and a hovering height of the UAV, and the method further comprises:
determining a fire severity of the target region based on the vegetation anomaly data;
determining the release dosage and the hovering height based on the fire severity; and
generating the release instruction based on the release dosage and the hovering height, and sending the release instruction to the emergency supervision object platform through the emergency supervision sensing network platform, to control the UAV to hover at the hovering height at the release location and release the fire-extinguishing material at the release dosage.

15. A non-transitory computer-readable storage medium, wherein the storage medium stores computer instructions, and when a computer reads the computer instructions in the storage medium, the computer executes the method according to claim 8.
